(19) United States
(12) Patent Application Publication
(10) Pub. No.: US 2011/0140851 A1
(43) Pub. Date: Jun. 16, 2011

(54) WAKEUP-ON-DEMAND APPARATUS AND MEHTOD, SENSOR DEVICE USING THE SAME, AND WAKEUP-ON-DEMAND METHOD OF SENSOR DEVICE

(75) Inventors: Byung Bog LEE, Daejeon (KR); Myung Nam Bae, Daejeon (KR); Jae Hong Ruy, Daejeon (KR); Byeong Cheol Choi, Daejeon (KR); In Hawn Lee, Daejeon (KR); Jong Arm Jun, Daejeon (KR)

(73) Assignee: Electronics and Telecommunications Research Institute, Daejeon (KR)

(21) Appl. No.: 12/914,394

(22) Filed: Oct. 28, 2010

(30) Foreign Application Priority Data
Dec. 11, 2009 (KR) 10-2009-0123213

(51) Int. Cl. H02J 13/00

(52) U.S. Cl. 340/9.1

(57) ABSTRACT

A wakeup-on-demand apparatus includes: a wakeup radio receiver (WRR) receiving a first radio signal to detect an address; and a main radio transceiver (MRT) responding to the first radio signal, transmitting and receiving a second radio signal for data communication, when the detected address coincides with a preset address.

### CROSS-REFERENCE TO RELATED APPLICATIONS

This application claims the priority of Korean Patent Application No. 10-2009-0123213 filed on Dec. 11, 2009, in the Korean Intellectual Property Office, the disclosure of which is incorporated herein by reference.

### BACKGROUND OF THE INVENTION

1. Field of the Invention

The present invention relates to a wakeup-on-demand apparatus and method, a sensor device using the same, and a wakeup-on-demand method of the sensor device, and more particularly, to a wakeup-on-demand apparatus and method, which is capable of reducing the power consumption of a device, a sensor device using the same, and a wakeup-on-demand method of the sensor device.

2. Description of the Related Art

Sensor devices forming a wireless sensor network based on IEEE 802.15.4 require a low-power technique, because they use battery power. The battery lifetime of the sensor devices serves as an important factor which may determine a sensor network lifetime and has an effect upon maintenance costs. In particular, the battery lifetime of the sensor devices is determined by an operation time of IEEE 802.15.4 compliant main radio transceiver (MRT) having high current consumption.

When a wireless sensor network is designed, information regarding an occurring event should be transferred to an information sink within several hundred ms (milliseconds). Such a process is essential to quickly detect the sensed information and deal with the detected information.

A scheduled rendezvous scheme, one of a range of schemes for designing a wireless sensor network, has a crucial problem regarding the sleep delay function for power saving. Furthermore, a currently existing access scheme in which a low-powered radio signal is used as a wakeup channel has a problem in that the transmission range of the wakeup radio signal does not reach 10 m.

Such problems limit the application range of a device using the above-described scheme. That is, the device may not even be able to wake up neighboring devices existing within the transmission range.

### SUMMARY OF THE INVENTION

An aspect of the present invention provides a wakeup-on-demand apparatus and method capable of reducing the power consumption of a device.

Another aspect of the present invention provides a wakeup-on-demand sensor device and a wakeup-on-demand method of the sensor device, capable of reducing power consumption.

According to an aspect of the present invention, there is provided a wakeup-on-demand apparatus including: a wakeup radio receiver (WRR) receiving a first radio signal to detect an address; and a main radio transceiver (MRT) responding to the first radio signal, transmitting and receiving a second radio signal for data communication, when the detected address coincides with a preset address.

The WRR may include: a start-of-frame-delimiter (SFD) pattern comparator detecting the start of a frame from the first radio signal; and an address decoder detecting the address from the first radio signal.

The address decoder may operate when the SFD pattern comparator detects the start of the frame from the received first radio signal.

The WRR may provide a signal to operate the MRT when the address decoder detects the address coinciding with the preset address from the first radio signal.

According to another aspect of the present invention, there is provided a wakeup-on-demand method which uses a WRR receiving a first radio signal to detect an address and an MRT responding to the first radio signal, transmitting and receiving a second radio signal for data communication when the detected address coincides with a preset address. The wakeup-on-demand method includes: receiving the first radio signal using the WRR; detecting the start of a frame from the received first radio signal; detecting the address from the received first radio signal; and operating the MRT.

The detecting of the address may be performed when the start of the frame is detected from the received first radio signal.

The WRR may provide a signal to perform the operation of the MRT, when an address coinciding with the preset address is detected from the received first radio signal.

According to another aspect of the present invention, there is provided a wakeup-on-demand sensor device including: a sensor sensing a predetermined phenomenon; a WRR receiving a first radio signal to detect an address; an MRT responding to the first radio signal, transmitting and receiving a second radio signal for data communication, when the detected address coincides with a preset address; and a micro controller unit (MCU) controlling the MRT.

The WRR may include: an SFD pattern comparator detecting the start of a frame from the first radio signal; and an address decoder detecting the address from the first radio signal.

The address decoder may operate when the SFD pattern comparator detects the start of the frame from the received first radio signal.

The WRR may provide a signal to operate the MRT when the address decoder detects the address coinciding with the preset address from the first radio signal.

The sensor may provide a signal to operate the MCU, when sensing the predetermined phenomenon.

The MCU may operate when receiving a signal to operate the MCU.

The MCU may control the MRT to operate, when the operation of the MRT is required.

The sensor device may predict an expected value of service time from when a data packet arrives at the sensor device to when the data packet is successfully transmitted or discarded and a battery lifetime of the sensor device.

According to another aspect of the present invention, there is provided a wakeup-on-demand method of a sensor device which includes: a sensor sensing a predetermined phenomenon; a WRR receiving a first radio signal to detect an address; an MRT responding to the first radio signal, transmitting and receiving a second radio signal for data communication, when the detected address coincides with a preset address; and an MCU controlling the MRT. The wakeup-on-demand method includes: receiving the first radio signal using the WRR; detecting the start of a frame from the received first radio signal; detecting the address from the received first radio signal; detecting, by the sensor, a predetermined phenomenon; operating the MCU; and operating the MRT.

The detecting of the address maybe performed when the start of the frame is detected from the received first radio signal.

The WRR may provide a signal to perform the operation of the MRT, when the address coinciding with the preset address is detected from the received first radio signal.

The sensor may provide a signal to perform the operation of the MCU, when sensing the predetermined phenomenon.

The MCU may operate when receiving a signal to operate the MCU, and controls he operation of the MRT, when the operation of the MRT is required.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram explaining a wakeup-on-demand apparatus according to an embodiment of the present invention;

FIG. 2 is a flow chart explaining a wakeup-on-demand method according to another embodiment of the present invention;

FIG. 3 is a block diagram explaining a wakeup-on-demand sensor device according to another embodiment of the present invention;

FIG. 4 is a conceptual diagram explaining a wakeup radio receiver (WRR) of the wakeup-on-demand sensor device according to the embodiment of the present invention;

FIG. 5 is a conceptual diagram explaining the wakeup-on-demand sensor device according to the embodiment of the present invention; and

FIG. 6 is a flow chart explaining a wakeup-on-demand method of a sensor device according another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

However, the present invention is not limited to specific embodiments, and may include all modifications, equivalents, and substitutes included in the technical spirit and scope of the present invention.

It will be understood that although the terms first and second are used herein to describe various elements, these elements should not be limited by these terms. These terms are only used to distinguish one element from another element. For example, a first element may be designated as a second element, without departing from the spirit and scope of the invention as defined by the appended claims. Similarly, the second element may be designated as the first element. The term and/or may include a combination of plural relevant described articles or any one of plural relevant described articles.

When it is stated that one component is ‘connected’ or ‘linked’ to another component, the one component may be directly connected or liked to another component. However, it will be understood that yet another component may exist therebetween. On the other hand, when it is described that one component is ‘directly connected’ or ‘directly linked’ to another component, it will be understood that yet another component does not exist therebetween.

The terms used in this specification are used for describing specific embodiments and do not limit the scope of the present invention. A singular expression may include a plural expression, as long as they are obviously different from each other in context. In this application, the meaning of ‘include’ or ‘have’ specifies a property, a fixed number, a step, a process, an element, a component, and/or a combination thereof but does not exclude other properties, fixed numbers, steps, processes, elements, components, and/or combinations thereof.

The terms used herein, including technical and scientific terms, have the same meanings as terms that are generally understood by those skilled in the art, as long as the terms are differently defined. It should be understood that terms defined in a generally-used dictionary have meanings coinciding with those of terms in the related technology. As long as the terms are not defined obviously, they are not ideally or excessively analyzed as formal meanings.

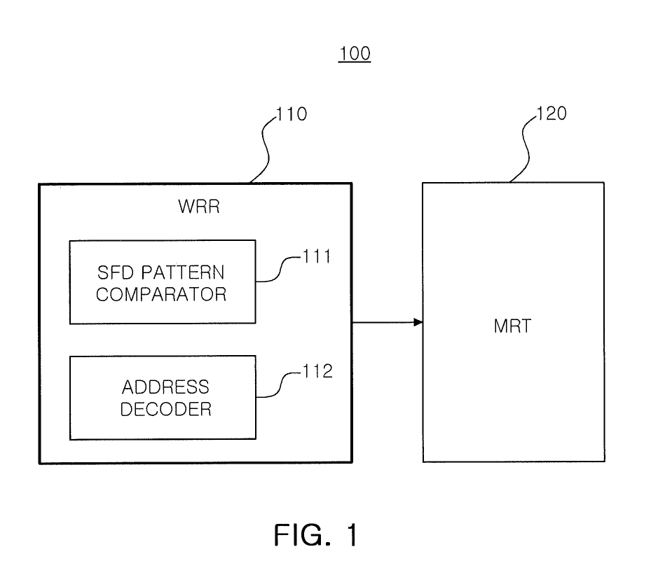

FIG. 1 is a block diagram explaining a wakeup-on-demand apparatus according to an embodiment of the present invention.

Referring to FIG. 1, the wakeup-on-demand apparatus 100 according to the embodiment of the present invention includes a wakeup radio receiver (WRR) 110 and a main radio transceiver (MRT) 120. The wakeup radio receiver 110 receives a first radio signal to detect an address. The MRT 120 responds to the first radio signal, transmits and receives a second radio signal for data communication, when the detected address coincides with a predetermined address.

The WRR 110, which receives the first radio signal to detect an address, may include a start-of-frame-delimiter (SFD) pattern comparator 111 detecting the start of a frame from the first radio signal and an address decoder 112 detecting the address from the first radio signal.

The SFD pattern comparator 111 may check whether or not an SFD indicating the start of the frame is included in the received first radio signal. The address decoder 112 may operate when the SFD pattern comparator 111 detects the start of the frame from the received first radio signal.

For example, when the SFD indicating the start of the frame is ‘b10100111’, the SFD pattern comparator 111 checks whether or not ‘b10100111’ exists in the received first radio signal. Depending on the check result, when the SFD exists in the received first radio signal, the address decoder 112 performs a subsequent operation. When the SFD does not exist in the received first radio signal, the address decoder 112 does not perform a subsequent operation because the first radio signal is a signal which cannot be processed. That is, the first radio signal may be monitored through the minimum of operation.

When the address decoder 112 detects an address coinciding with the preset address from the first radio signal, the WRR 110 may provide a signal to operate the MRT. That is, the address decoder 112 may check whether or not the first radio signal is a signal of which the destination is set to the address decoder 112.

For example, when the received first radio signal is not a signal of which the destination is set to the address decoder 112, the address decoder 112 does not need to perform decoding, even though an SFD exists in the first radio signal. That is, even when an SFD exists in received the first radio signal, the address decoder 112 may not perform decoding in the case where the first radio signal is not a signal of which the destination is set to the decoder 122. Therefore, it is possible to check whether or not the first radio signal is a signal to be processed through the minimum of operation.

The MRT 120 performs an operation only when the SFD exists in the received first radio signal and the destination address thereof coincides with the preset address which designates the MRT 120. In this case, the MRT 120 may perform a variety of operations including a response ACK to the first radio signal.

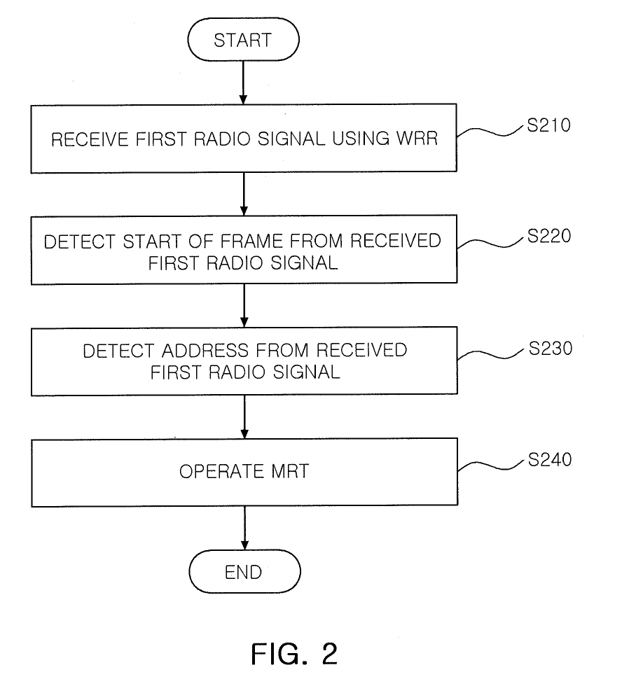

FIG. 2 is a flow chart explaining a wakeup-on-demand method according to another embodiment of the present invention.

Referring to FIG. 2, the wakeup-on-demand method according to the embodiment of the present invention, which uses a WRR receiving a first radio signal to detect an address and a MRT responding to the first radio signal, transmitting and receiving a second radio signal for data communication when the detected address coincides with a preset address, may include receiving the first radio signal using the WRR (S210), detecting the start of a frame from the received first radio signal (S220), detecting an address from the received first radio signal (S230), and operating the MRT (S240).

The detecting of the start of the frame (S220) may check whether or not an SFD indicating the start of the frame is included in the received first radio signal.

The detecting of the address (S230) may be performed when the start of the frame is detected from the received first radio signal. That is, the detecting of the start of the frame (S220) may previously determine whether the signal needs to be decoded or not, through the minimum of operation.

When an address coinciding with the preset address is detected from the received first radio signal, the WRR may provide a signal to perform the operation of the main radio transceiver (S240). That is, since the operation of the MRT (S240) is performed when the received first radio signal is correctly transferred to the MRT, the number of cases in which the operation is performed may be minimized. Therefore, it is possible to minimize power consumption.

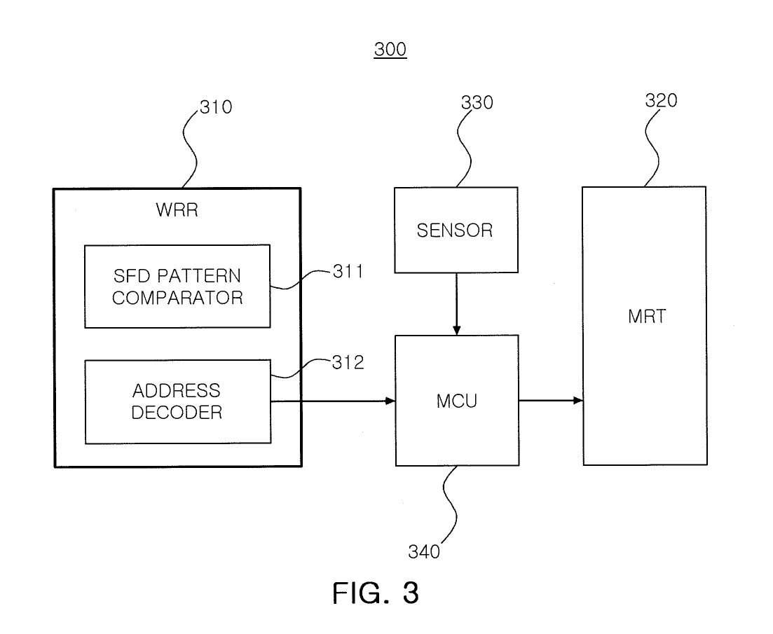

FIG. 3 is a block diagram explaining a wakeup-on-demand sensor device according to another embodiment of the present invention.

Referring to FIG. 3, the wakeup-on-demand sensor device 300 according to the embodiment of the present invention may include a sensor 330, a WRR 310, an MRT 320, and a micro controller unit (MCU) 340. The sensor 330 detects a predetermined phenomenon. The WRR 310 receives a first radio signal to detect an address. The MRT 320 responds to the first radio signal, transmits and receives a second radio signal for data communication, when the detected address coincides with a preset address. The MCU 340 controls the MRT 320.

A general sensor device may include a sensor 330, an MCU 340, an MRT 320, a battery (not shown), a WRR 310, and an antenna (not shown). The sensor 330 may sense physical phenomena in the real world at all times. The MCU 340 includes a built-in memory for processing and storing data. The MRT 320 transmits data and command packets modulated by an offset quadrature phase shift keying (OQPSK) modulation scheme of IEEE 802.15.4 and a wakeup call packet modulated by an on-off keying (OOK) modulation scheme to wake up adjacent sensor devices. The wakeup radio receiver 310 wakes up the MCU 340 and the MRT 320 in a sleep state, when receiving a wakeup call signal from an adjacent sensor device. The antenna transmits and receives wireless modulated signals.

In particular, the MRT 320 may be divided into an IEEE 802.15.4 radio transceiver (IRT) which transmits data and command packets modulated by the OQPSK modulation scheme and a wakeup radio transmitter (WRT) which transmits a wakeup call packet modulated by the OOK scheme.

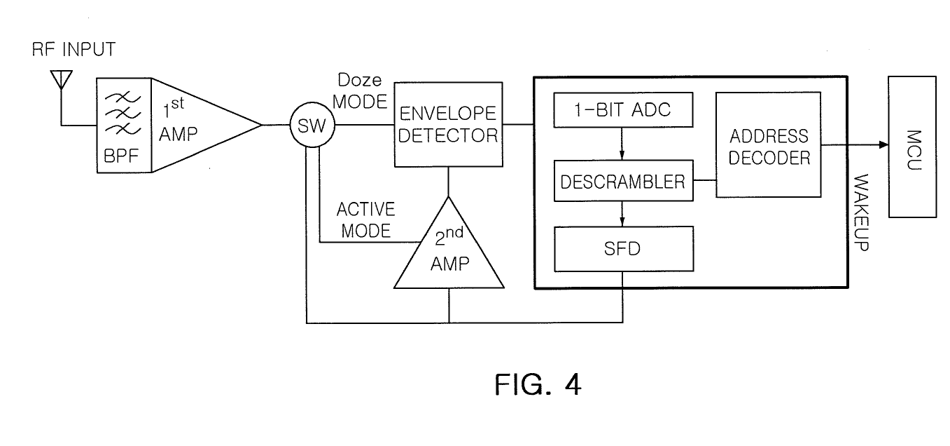

FIG. 4 is a conceptual diagram explaining the WRR of the wakeup-on-demand sensor device according to the embodiment of the present invention.

Referring to FIGS. 3 and 4, the WRR 310 of the wakeup-on-demand sensor device according to the embodiment of the present invention may include an SFD pattern comparator 311 detecting the start of a frame from the first radio signal and an address decoder 312 detecting an address from the first radio signal.

The wakeup-on-demand sensor device may use a plurality of radio signals including a wakeup radio signal as the first radio signal and a main radio signal as the second radio signal.

The main radio signal as the second radio signal may be applied to an IRT based on 2.4 GHz IEEE 802.15.4, and the wakeup radio signal as the first radio signal may be applied to a WRT based on the OOK modulation scheme. Furthermore, the main radio signal and the wakeup radio signal may be signals occupying the same frequency band. The main radio signal may be designed in such a manner as to operate in the range of 10 m to 30 m.

The IRT and the WRT may be designed in such a manner as to transmit data at data transmission rates of 250 Kbps in the OQPSK modulation scheme and 1 Kbps in the OOK modulation scheme.

The address decoder 312 in the WRR 310 may operate when the SFD pattern comparator 311 detects the start of the frame from the received first radio signal.

The WRR 310 may provide a signal to operate the MCU 340, when the address decoder 312 detects an address coinciding with the preset address from the first radio signal.

Referring to FIGS. 3 and 4, since the WRR 310 in the wakeup-on-demand sensor device 300 should be always maintained in an idle listening state, the WRR 310 has a much smaller amount of power consumption than the MRT 320.

In order to design the WRR 310 in a low-power type, the power domain may be divided in a doze mode and an active mode.

In the doze mode, a band pass filter (BPF) passing only a specific 2.4 GHz frequency band, a first amplifier, an envelope detector, a 1-bit analog-digital converter (ADC), a descrambler, the SFD pattern comparator and so on are activated to sample an input signal in accordance with a duty cycle clock.

The active mode is operated when an SFD pattern, b1010011, exists in the input signal sampled in the doze mode.

The active mode may include the first amplifier, a second amplifier, the envelope detector, the 1-bit ADC, the descrambler, and the address decoder. The descrambler converts data scrambled to uniformly distribute 1 and 0 sequences of a wakeup call signal modulated by the OOK modulation scheme, into original data. The address decoder analyzes a received address value to compare with the address of the sensor device.

In the active mode, the input signal corresponding to a field following the SFD of the wakeup call signal is sampled in accordance with the duty cycle clock.

When the address value coincides with the address of the sensor device after the wakeup call signal is sampled, the MCU 340 in the sleep state is woken up, and then wakes up the MRT 320. The woken-up MCU 340 controls the MRT 320 to transmit an ACK signal for the wakeup call signal to an adjacent device having transmitted the wakeup call signal.

The wakeup call signal includes an SFD (b0 to b7), 1 bit (b8) reserved for subsequent application, a sync field (b9 to b14) corresponding to an address synchronization header for address field synchronization, an address field (b15 to b22), and a parity field (b23) for authenticating the address field value. The address field and the parity field are encoded in a Manchester pattern.

After the address information is completed, the WRR 310 changes into the doze mode from the active mode. A period of time required for changing from the active mode into the doze mode may be smaller than 30 μs.

The MCU 340 may have features of a strong 16 bit RISC CPU and a 16 bit register. On the MCU 340, a WMAC protocol may be loaded and executed.

Referring to FIGS. 3 and 4, the sensor 330 in the wakeup-on-demand sensor device 300 may provide a signal to operate the MCU, when sensing the predetermined phenomenon.

In a general event-driven operation, the sensor is operated by a low-power pre-processor which continuously performs sampling for the operation. That is, the pre-processor is always maintained in a power-on state and in the active mode.

The pre-processor filters the first order for data. When detecting a specific operation and phenomenon, the pre-processor wakes up the MCU 340. When a desired event is detected, the MCU 340 performs a required operation, and if necessary, controls the MRT 320 to transmit the operation result to an adjacent device.

Referring to FIGS. 3 and 4, the MCU 340 in the wake-up-demand sensor device 300 may operate when receiving a signal to operate the MCU 340. Furthermore, the MCU 340 controls the MRT 320 to operate, when the operation of the MRT 320 is required.

The sensor device may reduce the power consumption by maintaining the MCU 340 and the MRT 320 in a power down state until a required event occurs.

The detecting of the required event and the waking-up of other components are performed by the WRR or the sensor in the doze mode.

The WRR 310 and/or the sensor 330 tests whether or not an assumptive event exists in an input terminal, using a simple hypothesis function. When the assumption is proved, the WRR 310 or the sensor 330 wakes up the MCU 340 to process information.

When it is determined that the information is not important, the sensor device discards the information, and then returns to the doze mode. On the other hand, when the information is determined to be important, the data is stored in a memory. When a predefined transmission buffer is full, the sensor device waits to transmit the data to another device.

Therefore, the MCU 340, which is woken up when the buffer is full, performs clear channel assessment (CCA), and wakes up the MRT 320 to transmit a wakeup command and a data packet.

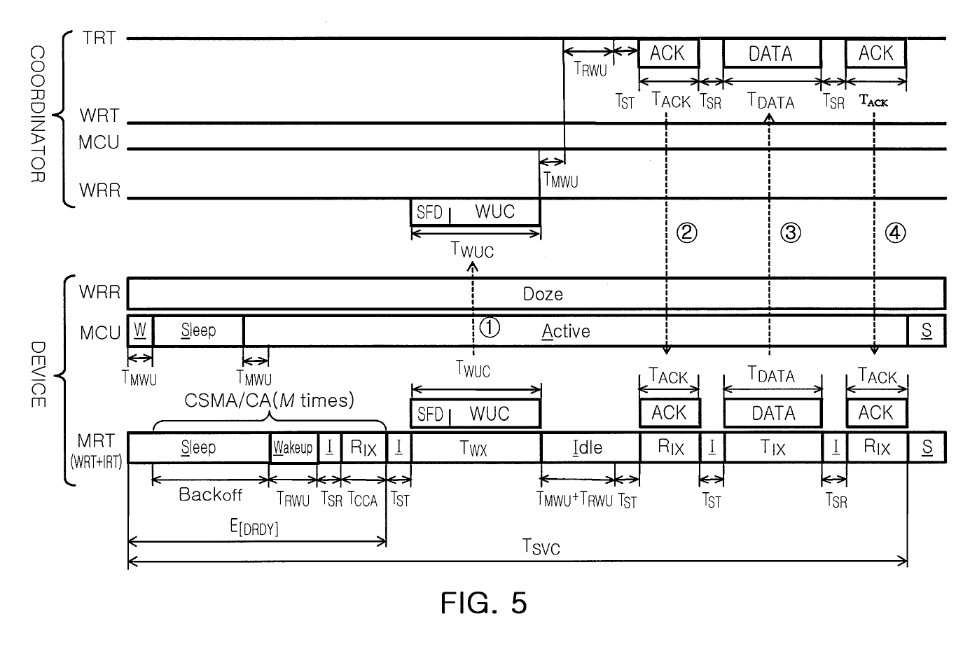

FIG. 5 is a conceptual diagram explaining the wakeup-on-demand sensor device according to the embodiment of the present invention.

Referring to FIGS. 3 and 5, the following descriptions will be made from the device view.

A device should wake up a coordinator in a sleep state, before transmitting event data to the coordinator. In order to transmit a wakeup call signal for waking up the coordinator, the device performs a carrier sense multiple access/collision avoidance (CSMA/CA) process to check the state of a wireless channel. In the CSMA/CA process, the device wakes up the MRT in a sleep state within an MRT wakeup time T_{RWU} after a backoff time, converts the MRT into a receive mode within a turnaround time T_{SR} between the transmit and receive modes, and checks the state of the wireless channel during a time T_{CCA} for performing a carrier sense. In the CSMA/CA process, the MRT maintains an idle state during the time T_{SR}, and maintains the sleep state and the wakeup state during the backoff time and the MRT wakeup time T_{RWU}, respectively.

When the wireless channel state is busy, the device repeats the CSMA/CA process by the maximum number M of preamble retransmissions. When the wireless channel state is busy, even after the CSMA/CA process is repeated by the maximum number M, the device processes the transmission of wakeup call packet as a fail. When the wireless channel state is idle, the MRT in the idle state is converted into the transmit mode within a turnaround time T_{ST} between the transmit and receive modes, and transmits a wakeup call packet modulated by the OOK modulation scheme during a wakeup-command transmission time T_{WUC} of the MRT. The MRT maintains the state of a time T_{WX}, for transmitting with the WRT, while transmitting the wakeup call packet.

To receive an ACK signal of the transmitted wakeup call signal after a time required for waking up electronic circuits of the MCU and the IRT of the coordinator, the device sets the MRT into the receive mode within the turnaround time T_{SR} such that the MRT is converted into the idle state.

The MRT of the device in the idle state receives an ACK packet for the wakeup call signal from the coordinator, in the receive mode. The MRT maintains the state of a time R_{IX} for receiving with the IRT, while receiving the ACK packet.

To transmit a user data packet to the coordinator, the device converts the MRT in the idle state into the transmit mode within the turnaround time T_{ST}, and then controls the MRT to transmit the user data. The MRT maintains the state of a time T_{IX} for transmitting with the IRT, while transmitting the user data packet.

To receive an ACK packet of the user data packet, the device sets the MRT into the receive mode within the turnaround time T_{SR}, and maintains the MRT in the idle state.

The MRT of the device in the idle state receives the ACK packet of the user data packet from the coordinator, in the receive mode. The MRT maintains the state of the time R_{IX}, while receiving the ACK packet of the user data packet.

Referring to FIGS. 3 and 5, the following descriptions will be made from the coordinator view.

When the coordinator receives data from the device, the WRR of the coordinator in the doze state receives a wakeup call packet transmitted by the device during the wakeup-command transmission time T_{WUC}. When an address field value of the received packet coincides with the address value of the coordinator, the WRR of the coordinator transfers an interrupt signal to the MCU to wake up the MCU in the sleep state. Then, the MCU is converted into the active mode from the sleep mode after an MCU wakeup time T_{MWU}.

The MCU in the active mode wakes up the IRT of the MRT to transmit an ACK packet for the wakeup call packet.

The MRT woken up during the MRT wakeup time T_{RWU} is set in the transmit mode so as to play a role as the IRT.

The MCU generates an ACK packet of the wakeup call packet and controls the MRT to transmit the generated ACK packet to the device having transmitted the wakeup call packet.

The coordinator having transmitted the ACK packet for the wakeup call packet is converted into the receive mode within the turnaround time T_{SR}, in order to receive a user data packet from the device.

The coordinator receives a user data packet during a data transmission time T_{DATA} , and is converted into the transmit mode within the turnaround time T_{ST} to transmit an ACK packet for the received packet.

The MCU generates an ACK packet for the received user data packet, and controls the MRT to transmit the generated ACK packet to the device having transmitted the user data packet. Then, the MRT and the MCU are converted into the sleep mode.

Referring to FIG. 3, the sensor device 300 may predict a service-time expected value T_{SVC} and a battery lifetime L of the sensor device. The service-time expected value T_{SVC} refers to a time from when a data packet arrives at the sensor device to when the data packet is successfully transmitted or discarded.

In this embodiment, it is assumed that each of n devices (where n is a natural number which ranges from 1 to 127 {1≦n≦127}) connected to the coordinator generates a packet at a rate of λ in accordance with the Poisson process and transmits and receives the packet. Furthermore, it is assumed that data packets have a constant size and a constant transmission time. In this case, the probability behaviors of a tagged device in a stochastic process model {X(t), t≧0} may be described as follows.

That is, X(t)=Doze indicates a case in which the device waits for an SFD of a wakeup call packet at time t, X(t)=Backoff indicates a case in which the device is in the backoff process at time t, X(t)=CCA indicates a case in which the device is in the CCA state at time t, X(t)=T_{WX} indicates a case in which the device is transmitting a wakeup call packet at time t, and X(t)=T_{IX} indicates a case in which the device is transmitting an IEEE 802.15.4 packet at time t.

The device tagged for analysis is modeled in accordance with a busy model of an M/G/1 queuing system. Furthermore, services times are independent from each other and identically distributed. The service time refers to a time from when a data packet arrives at a queue to when the data packet is successfully transmitted or discarded, and tₖ refers to a time at which a k-th busy period of the M/G/1 queuing system is terminated. Then, when the busy cycle of the M/G/1 queue is a regenerative process, {X(t), t≧0} becomes a regenerative cycle. In the regenerative process, an expected fraction of time in which the system is in a predetermined state is identical to an expected fraction of time during a single cycle in which the system is in a predetermined state.

When stating the CCA while another device transmits a packet, the tagged device detects that a channel is busy. Since all the other (n-1) devices have an equal opportunity at which they can transmit a packet during one busy cycle of the tagged device, they statistically have one regenerative point. Therefore, the average number of successful transmissions of a single device during one busy cycle may be calculated by (1−P−ₗₒₛₛ)·E[Γ]. Here, Pₗₒₛₛ represents a packet loss probability, Γ represents the number of packets provided during the busy period of the M/G/1 queuing system, and E[Γ] may be expressed by E[Γ]=1/(1−ρ). Here, the traffic intensity ρ is expressed by ρ=λ·T_{SVC}, and T_{SVC} represents an expected value of the service time of the M/G/1 queuing system.

The service time refers to a period of time from when a data packet arrives at a queue to when the data packet is successfully transmitted or discarded. The expected value T_{SVC} of the service time in the M/G/1 queuing system may be expressed as Equation 1 below.

T_{SVC}=E[D_{RDY}]+T_{WUC}+T_{MWC}+T_{RWU}+2·T_{ACK}+T_{DATA}+2·T_{ST}+2·T_{SR} [Equation 1]

Here, E[D_{RDY}] represents an expected delay value indicating an interval from when a data packet arrives at the queue to immediately before a wakeup call packet is transmitted or discarded. Furthermore, T_{WUC} represents a transmission time of the wakeup call packet, T_{MWC} represents a wakeup time of the MCU, T_{RWU} represents a wakeup time of the MRT, T_{ACK} represents a transmission time of an ACK packet, T_{DATA} represents a transmission time of data, and T_{ST} and T_{SR} represent transmit-to-receive and receive-to-transmit turnaround times, respectively.

A time occupied by the (n-1) devices of which the channels are in the busy cycle is (n-1)·(1−Pₗₒₛₛ)·(E[Γ])·T_{RT}.

Here, Pₗₒₛₛ represents a packet loss probability, E[Γ] may be expressed by E[Γ]=1/(1−ρ), and T_{RT} satisfies the following equation: T_{RT}=(T_{CCA}+T_{WUC}+T_{MWU}+T_{RWU}+2·T_{ACK}+T_{DATA}+2·T_{ST}+2·T_{SR}).

The channel busy probability in the CCA process is equal to a probability a in which the channel is to be busy when the tagged device is not in a transmission state. Therefore, the probability α is calculated by Equation 2 below.

$$α = \frac{( n - 1 ) \cdot ( 1 - {P}_{loss} ) \cdot E [ Γ ] \cdot {T}_{RT}}{\frac{1}{λ} + E [ Γ ] \cdot E [ {D}_{RDY} ]} \qquad [ Equation 2 ]$$

Here, λ represents a value which is larger than 0 and smaller than 1/T_{SVR}, E[Γ] may be expressed by E[Γ]=1/(1−ρ), E[D_{RDY}] represents an expected delay value indicating an interval of time from when a data packet arrives at a queue to immediately before a wakeup call packet is transmitted or discarded.

To calculate the expected delay value E[D_{RDY}], a concept of Wᵢ=min{2ⁱ·Wₘᵢₙ, Wₘₐₓ} is introduced, where Wₘᵢₙ=2^{BEmin} and Wₘₐₓ=2^{BEmax}·BEₘᵢₙ and BEₘₐₓ represent a minimum backoff exponent (macMinBE) and a maximum backoff exponent (macMaxBE), respectively. The default values of the exponents are 3 and 5, respectively. Then, the expected delay value E[D_{RDY}] may be formalized as Equation 3 below.

$$E [ {D}_{RDY} ] = {T}_{MWU} + {N}_{CCA} \cdot ( {T}_{MWU} + {T}_{RWU} + {T}_{SR} ) + {\sum }_{v = 0}^{M} {α}^{v} \cdot ( 1 - α ) \{ {\sum }_{i = 0}^{v} \frac{{W}_{i} - 1}{2} \cdot σ + ( v + 1 ) \cdot {T}_{CCA} \} + {α}^{M + 1} \{ {\sum }_{i = 0}^{M} \frac{{W}_{i} - 1}{2} \cdot σ + ( M + 1 ) \cdot {T}_{CCA} \} \qquad [ Equation 3 ]$$

Here, N_{CCA} may be expressed as Equation 4 below.

N_{CCA}=Σᵢ₌₀^{M}αⁱ·(1−α)·α^{(M+1)}·(M+1) [Equation 4]

Here, σ represents the length of a backoff slot, T_{MWU} and T_{RWU} represents times required for waking up the MCU and the MRT in the sleep mode, respectively, and N_{CCA} represents the average of CCAs until a packet is successfully transmitted or discarded in Equation 4. The first and second line in Equation 3 coincides with a case in which a packet is successfully transmitted, and the third line in Equation 3 coincides with a case in which (M+1) attempts for a packet to perform the CCA are failed. Therefore, the packet loss probability Pₗₒₛₛ may be expressed as Equation 5 below.

Pₗₒₛₛ=α^{M+1} [Equation 5]

Here, α is expressed as a term for E[D_{RDY}], N_{CCA}, and Pₗₒₛₛ, as in Equation 2. Furthermore, E[D_{RDY}] in Equation 3, N_{CCA} in Equation 4, and Pₗₒₛₛ in Equation 5 are represented as terms of α, respectively. Therefore, Equations 2, 3, and 5 which are non-linear equations may be solved so as to obtain the necessary value α. As a result, E[D_{RDY}], N_{CCA}, and Pₗₒₛₛ may be derived.

An expected delay value E[D] from when data arrives at the device to immediately after a wakeup call packet is transmitted or discarded by calculation based on the theory of the M/G/1 queuing system may be expressed as Equation 6 below.

$$E [ D ] = \frac{λ \cdot {( {T}_{SVC} )}^{2}}{2 ( 1 - ρ )} + E [ {D}_{RDY} ] \qquad [ Equation 6 ]$$

In the embodiments of the present invention, average current consumption E which is one of main performance items may be calculated in unit of mA/msec by Equation 7 below.

$$E = \frac{E [ Γ ] \cdot ( {E}_{MCU} + {E}_{MRT} + {E}_{OHEAR} )}{( 1 / λ + E [ Γ ] \cdot ( {T}_{SVC} + E [ D ] - E [ {D}_{RDY} ] )} + {E}_{IS} + {E}_{MS} + {E}_{WD} \qquad [ Equation 7 ]$$

Here, E_{MCU} is calculated as follows:

E_{MCU}=(E_{MWU}−E_{MS})·T_{MWU}+(E_{MA}−E_{MS})·{N_{CCA}·(T_{MWU}+T_{RWU}+T_{SR}+T_{CCA})+T_{SVC}−E[D_{RDY}]}.

Furthermore, E_{MRT} is calculated as follows:

E_{MRT}=(E_{RWU}−E_{IS})·_{CCA}·T_{RWU}+(E_{IR}−E_{IS})·N_{CCA}·T_{CCA}+(E_{II}−E_{IS}){N_{CCA}·T_{SR}+T_{MWU}+T_{RWU}+2·T_{SR}+2·T_{ST})+2·(E_{IR}−E_{IS})·T_{ACK}+(E_{IT}−E_{IS})·T_{DATA}+(E_{WT}−E_{IS})·T_{WUC}.

The symbols may be referred to in the following table.

| Symbol | Note |
|---|---|
| E_{IS} | Average current consumption in sleep mode of IRT |
| E_{II} | Average current consumption in idle mode of IRT |
| E_{IT} | Average current consumption during packet transmission |
| | of IRT |
| E_{IR} | Average current consumption during packet reception of |
| | IRT |
| E_{WS} | Average current consumption in sleep mode of WRT |
| E_{WD} | Average current consumption in doze mode of WRR |
| E_{WT} | Average current consumption during wakeup call |
| | transmission of WRT |
| E_{WR} | Average current consumption during packet reception of |
| | WRR |
| E_{MS} | Average current consumption in sleep mode of MCU |
| E_{MA} | Average current consumption in active mode of MCU |
| E_{MWU} | Average current consumption in wakeup mode of MCU |
| E_{RWU} | Average current consumption in wakeup mode of MRT |

In addition, considering that the wakeup call packet is overheard, E_{OHEAR} may be expressed as the following equation: E_{OHEAR}=(n-1)·T_{OHEAR}·(E_{WR}−E_{WD}). Here, E_{OHEAR} may be equal to a transmission time of a wakeup physical layer protocol data unit (PPDU) which does not have a synchronization header delimiter (SHD) field.

The energy consumption in each power mode may be considered as current consumption in unit of milliseconds. The time element becomes a period in unit of milliseconds. As a result, the lifetime L of the battery is calculated as Equation 8 below.

$$L = \frac{{E}_{TOTAL}}{E} \qquad [ Equation 8 ]$$

Here, E_{TOTAL} represents an initial current capacity of the battery energy.

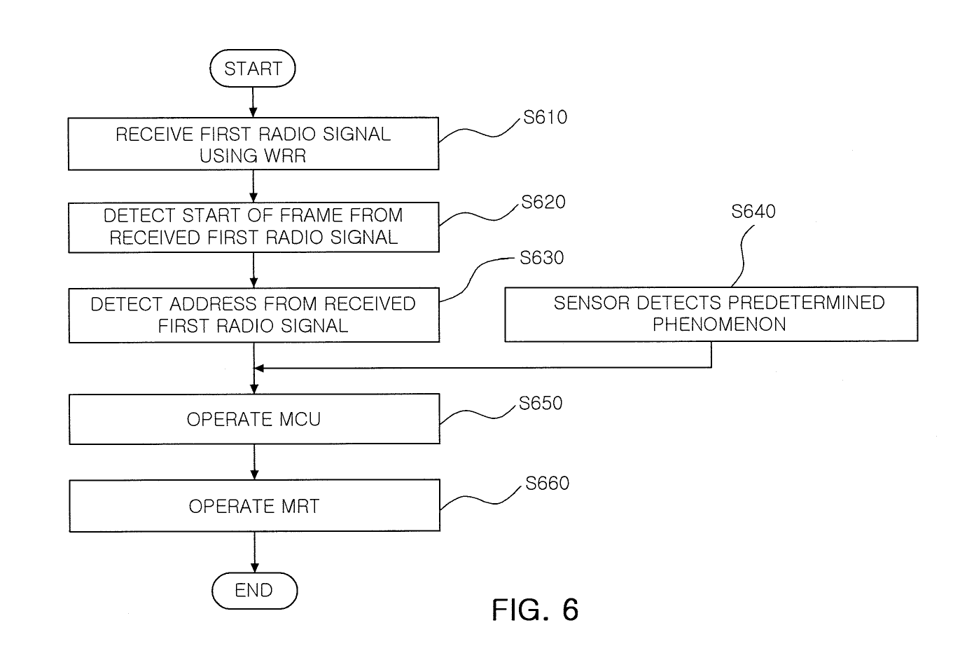

FIG. 6 is a flow chart explaining a wakeup-on-demand method of a sensor device according another embodiment of the present invention.

Referring to FIG. 6, the wakeup-on-demand method of the sensor device according to the embodiment of the present invention, the sensor device including: a sensor detecting a predetermined phenomenon; a WRR receiving a first radio signal to detect an address; an MRT responding to the first radio signal, transmitting and receiving a second radio signal for data communication, when the detected address coincides with a preset address; and an MCU controlling the MRT, may include: receiving the first radio signal using the WRR (S610); detecting the start of a frame from the received first radio signal (S620); detecting an address from the received first radio signal (S630); sensing, by the sensor, the predetermined phenomenon (S640); operating the MCU (S650); and operating the MRT (S660).

The detecting of the address (S630) may be performed when the start of the frame is detected from the received first radio signal in the detecting of the start of the frame (S620).

When an address coinciding with the preset address is detected from the received first signal in the detecting of the address (S630), the WRR may provide a signal to perform the operation of the MCU (S650).

When the sensor senses the predetermined phenomenon in the sensing of the predetermined phenomenon (S640), the sensor may provide a signal to perform the operation of the MCU (S650).

In the operation of the MCU (S650), the MCU is operated when receiving a signal to operate the MCU. The MCT may control the MRT to operate, when the operation of the MRT is required.

That is, the operating of the MCU (S650) may be performed when a signal is received to operate the MCU in any one of the detecting of the address (S630) and the sensing of the predetermined phenomenon (S640). Accordingly, the MCU may control the MRT to operate, when the operation of the MRT is required.

According to the embodiments of the present invention, the power consumption of the device may be reduced, and the balance of the end-to-end delay time of the device may be obtained. In particular, the performance measurement of the device may be used for determining the optimal number of devices forming a sensor network which satisfies a quality of service (QoS) required under the limitation of average packet delay and average packet loss probability, and the battery lifetime of the device may be predicted.

While the present invention has been shown and described in connection with the exemplary embodiments, it will be apparent to those skilled in the art that modifications and variations can be made without departing from the spirit and scope of the invention as defined by the appended claims.

What is claimed is:

1. A wakeup-on-demand apparatus comprising:
a wakeup radio receiver (WRR) receiving a first radio signal to detect an address; and
a main radio transceiver (MRT) responding to the first radio signal, transmitting and receiving a second radio signal for data communication, when the detected address coincides with a preset address.

2. The wakeup-on-demand apparatus of claim 1, wherein the WRR comprises:
a start-of-frame-delimiter (SFD) pattern comparator detecting the start of a frame from the first radio signal; and
an address decoder detecting the address from the first radio signal.

3. The wakeup-on-demand apparatus of claim 2, wherein the address decoder operates when the SFD pattern comparator detects the start of the frame from the received first radio signal.

4. The wakeup-on-demand apparatus of claim 2, wherein the WRR provides a signal to operate the MRT when the address decoder detects the address coinciding with the preset address from the first radio signal.

5. A wakeup-on-demand method which uses a wakeup radio receiver (WRR) receiving a first radio signal to detect an address and a main radio transceiver (MRT) responding to the first radio signal, transmitting and receiving a second radio signal for data communication when the detected address coincides with a preset address, the wakeup-on-demand method comprising:
receiving the first radio signal using the WRR;
detecting the start of a frame from the received first radio signal;
detecting the address from the received first radio signal; and
operating the MRT. 15

6. The wakeup-on-demand method of claim 5, wherein the detecting of the address is performed when the start of the frame is detected from the received first radio signal.

7. The wakeup-on-demand method of claim 5, wherein the WRR provides a signal to perform the operation of the MRT, when an address coinciding with the preset address is detected from the received first radio signal.

8. A wakeup-on-demand sensor device comprising:
a sensor sensing a predetermined phenomenon;
a wakeup radio receiver (WRR) receiving a first radio signal to detect an address;
a main radio transceiver (MRT) responding to the first radio signal, transmitting and receiving a second radio signal for data communication, when the detected address coincides with a preset address; and
a micro controller unit (MCU) controlling the MRT.

9. The wakeup-on-demand sensor device of claim 8, wherein the WRR comprises:
a start-of-frame-delimiter (SFD) pattern comparator detecting the start of a frame from the first radio signal; and
an address decoder detecting the address from the first radio signal.

10. The wakeup-on-demand sensor device of claim 9, wherein the address decoder operates when the SFD pattern comparator detects the start of the frame from the received first radio signal.

11. The wakeup-on-demand sensor device of claim 9, wherein the WRR provides a signal to operate the MRT when the address decoder detects the address coinciding with the preset address from the first radio signal.

12. The wakeup-on-demand sensor device of claim 8, wherein the sensor provides a signal to operate the MCU, when sensing the predetermined phenomenon.

13. The wakeup-on-demand sensor device of claim 8, wherein the MCU operates when receiving a signal to operate the MCU.

14. The wakeup-on-demand sensor device of claim 8, wherein the MCU controls the MRT to operate, when the operation of the MRT is required.

15. The wakeup-on-demand sensor device of claim 8, wherein the sensor device predicts an expected value of service time from when a data packet arrives at the sensor device to when the data packet is successfully transmitted or discarded and a battery lifetime of the sensor device.

16. A wakeup-on-demand method of a sensor device which comprises: a sensor sensing a predetermined phenomenon; a wakeup radio receiver (WRR) receiving a first radio signal to detect an address; a main radio transceiver (MRT) responding to the first radio signal, transmitting and receiving a second radio signal for data communication, when the detected address coincides with a preset address; and a micro controller unit (MCU) controlling the MRT, the wakeup-on-demand method comprising:
receiving the first radio signal using the WRR;
detecting the start of a frame from the received first radio signal;
detecting the address from the received first radio signal;
detecting, by the sensor, a predetermined phenomenon;
operating the MCU; and
operating the MRT.

17. The wakeup-on-demand method of claim 16, wherein the detecting of the address is performed when the start of the frame is detected from the received first radio signal.

18. The wakeup-on-demand method of claim 16, wherein the WRR provides a signal to perform the operation of the MRT, when the address coinciding with the preset address is detected from the received first radio signal.

19. The wakeup-on-demand method of claim 16, wherein the sensor provides a signal to perform the operation of the MCU, when sensing the predetermined phenomenon. 25

20. The wakeup-on-demand method of claim 16, wherein the MCU operates when receiving a signal to operate the MCU, and controls the MRT to operate, when the operation of the MRT is required.
